(19) United States
(12) Patent Application Publication
(10) Pub. No.: US 2021/0004741 A1
(43) Pub. Date: Jan. 7, 2021

(54) PROVIDING USEFUL SETS OF TOP-K QUALITY PLANS

(71) Applicant: INTERNATIONAL BUSINESS MACHINES CORPORATION, Armonk, NY (US)

(72) Inventors: Michael KATZ, Elmsford, NY (US); Octavian UDREA, Valhalla, NY (US); Shirin SOHRABI ARAGHI, Briarcliff Manor, NY (US)

(73) Assignee: INTERNATIONAL BUSINESS MACHINES CORPORATION, Armonk, NY (US)

(21) Appl. No.: 16/459,324

(22) Filed: Jul. 1, 2019

(51) Int. Cl. G06Q 10/06; G06N 5/02; G06N 20/00

(52) U.S. Cl. CPC G06Q 10/06311; G06N 20/00; G06N 5/022; G06Q 10/06395

(57) ABSTRACT

Embodiments are provided for providing top-K quality plans streaming applications in a computing environment. A set of top-K quality plans using a quality bound for a planning problem. The planning problem may be reformulated in one or more subsequent iterations and forbidding use one or more of the set of top-K quality plans. Identifying one or more of the set top-K quality plans having a quality less than the quality bound during the one or more subsequent iterations.

### BACKGROUND OF THE INVENTION

### Field of the Invention

The present invention relates in general to computing systems, and more particularly, to various embodiments for providing useful sets of top-K quality plans in a computing environment using a computing processor.

### Description of the Related Art

In today's society, computer systems are commonplace. Computer systems may be found in the workplace, at home, or at school. Computer systems may include data storage systems, or disk storage systems, to process and store data. In recent years, both software and hardware technologies have experienced amazing advancement. With the new technology, more and more functions are added and greater convenience is provided for use with these electronic appliances. The amount of information to be processed nowadays increases greatly. Therefore, processing, storing, and/or retrieving various amounts of information is a key problem to solve.

### SUMMARY OF THE INVENTION

Various embodiments for providing useful sets of top-K quality plans in a computing environment by a processor, are provided. In one embodiment, by way of example only, a method for providing top-K quality plans in a computing environment, again by a processor, is provided. A set of top-K quality plans using a quality bound for a planning problem. The planning problem may be reformulated in one or more subsequent iterations and forbidding use of one or more of the set of top-K quality plans. Identifying one or more of the set top-K quality plans having a quality less than the quality bound during the one or more subsequent iterations.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting an exemplary functional relationship between various aspects of the present invention;

FIG. 5 is an additional block diagram depicting operations for providing useful sets of top-K quality plans in which aspects of the present invention may be realized;

FIG. 6 is a flowchart diagram depicting an exemplary method for providing top-K quality plans by a processor in which aspects of the present invention may be realized; and

FIG. 7 is a flowchart diagram depicting an additional exemplary method for providing useful sets of top-K quality plans by a processor, again in which aspects of the present invention may be realized.

### DETAILED DESCRIPTION OF THE DRAWINGS

Automated planning and scheduling is a branch of artificial intelligence (AI) that concerns the realization of strategies or action sequences, typically for execution by intelligent agents, autonomous robots, and unmanned vehicles. Unlike classical control and classification problems, solutions are complex and must be discovered and optimized in multidimensional space. Planning is also related to decision theory. Planning may be performed such that solutions may be found and evaluated prior to execution; however, any derived solution often needs to be revised. Solutions usually resort to iterative trial and error processes commonly seen in artificial intelligence. These include dynamic programming, reinforcement learning, and combinatorial optimization.

A planning problem generally comprises the following main elements: a finite set of facts, the initial state (a set of facts that are true initially), a finite set of action operators (with precondition and effects), and a goal condition. An action operator maps a state into another state. In the classical planning, the objective is to find a sequence of action operators (or planning action) that, when applied to the initial state, will produce a state that satisfies the goal condition. This sequence of action operators is called a plan.

While the main focus in classical planning is on producing a single plan, a variety of applications require the need for finding a set of plans rather than one such as, for example, malware detection, plan recognition as planning and its applications, human team planning, explainable AI, and/or re-planning and plan monitoring

However, finding a set of plans rather than one plan is a challenge that diverse and top-k planning have attempted to solve. While diverse planning focuses on the difference between pairs of plans, the focus of top-k planning is on the quality of each individual plan. In one aspect, diverse planning may introduce additional restrictions on solution quality. Naturally, there are application domains where diversity plays the major role and domains where quality is the predominant feature. In both cases, however, the amount of produced plans is somewhat an artificial constraint, and the actual number has little meaning and is intended solely to ensure that a sufficient number of plans is found. Moreover, in top-k planning, the k parameter is given, describing the number of required plans, and the goal is to obtain k plans, with no better plan existing outside the found set. This, however, is a limitation, since there could be many plans that are essentially semantically equivalent, but syntactically different (e.g., reorderings of the same plan). Further, generating all possible valid orderings of an already found plan is a huge bottleneck that cannot be avoided in the top-k setting. Thus, a need exists to finding useful sets of the best or “optimal” set of plans with a quality bound specified either directly or as a function of the optimal quality.

Accordingly, various embodiments are provided herein for generating useful sets of top-K quality plans with a quality bound specified either directly or as a function of the optimal quality. In one aspect, the present invention provides a new or “enhanced” computational problem called top-quality planning, where a solution validity is defined through plan “quality bound” rather than an arbitrary number of plans. That is, “quality bound” may be a value/number and the solution validity may be that the solution is valid if the costs are no higher/larger than the bound. Switching to bounding plan quality allows to implicitly represent a sets of plans. In particular, use of a quality bound makes it possible to represent sets of valid plan re-orderings with one, single plan. All reorderings may be specified implicitly and encoded by a single plan. Iterative operation that find/identify a plan, forbid the plan for use by reformulating the problem and find the next plan are especially useful and can be adapted to this setting by 1) forbidding exactly a plan provided and all its possible reorderings, and/or 2) forbidding exactly a collection of plans provided and all their possible reorderings.

That is, the present invention may determine/compute a set of top quality plans, with the quality bound specified either directly or as a function of the optimal quality. All reorderings may be specified implicitly, encoded by a single plan. One or more iterative operations may be performed to identify a plan and forbid use of the plan by reformulating the planning problem and find the next plan. In association with the reformulation operations, the iterative operations may forbid exactly an identified plan and all its possible reorderings, or forbid exactly a collection of plans provided and all their possible reorderings.

In one aspect, the present invention provides for identifying high-quality plans rather than identifying just any plan, as well as identifying a cost associated with action operators utilized in identifying the plan. In one aspect, “quality” may refer to a shortest plan. Additionally, a best plan, optimal plan, or a highest-quality plan may be defined as a plan with smallest number of action operators. Also, a cost may be associated with each action operator, where the cost associated with each action operator is a penalty identified by a numerical value. Hence, the cost of the plan may be calculated by summing up the cost (i.e., the numerical value) of each action operator in the plan. Consequently, high-quality plans are those with the lowest cost and a top subset (k) of those plans, i.e., top-k plans, are the best k plans with the lowest cost.

Thus, the present invention provides for top quality planning to find and concisely represent a set of all plans of a bounded quality for a given (absolute) bound. That is, an alternative definition of solution validity may refer to bounding the solution quality instead of bounding the number of plans. This enables the present invention to define an equivalence relation on plans and implicitly represent equivalence classes plans without knowing the exact number of plans in the set. In one aspect, the equivalence relation may be defined by all possible re-orderings of each plan, represented by one canonical plan. Furthermore, a first planner may be provided for unordered top-quality planning that iteratively finds a single plan of top quality and forbids at once all plans found so far, including all their possible re-orderings. For that, the present invention provides for diverse planning reformulation that forbids a single multiset of actions to forbid exactly a collection of multisets. In this way, the reformulation operation enables forbidding of multiple sets of plans at each iteration.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

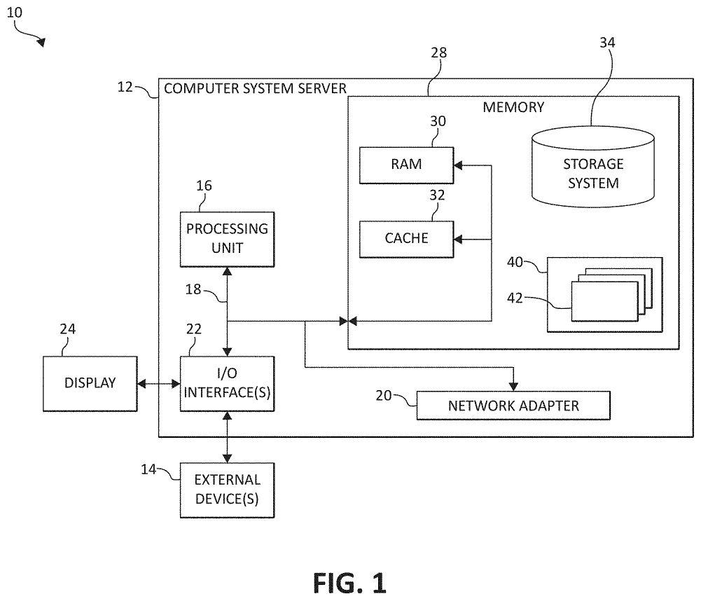

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16 (which may be referred to herein individually and/or collectively as “processor”), a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

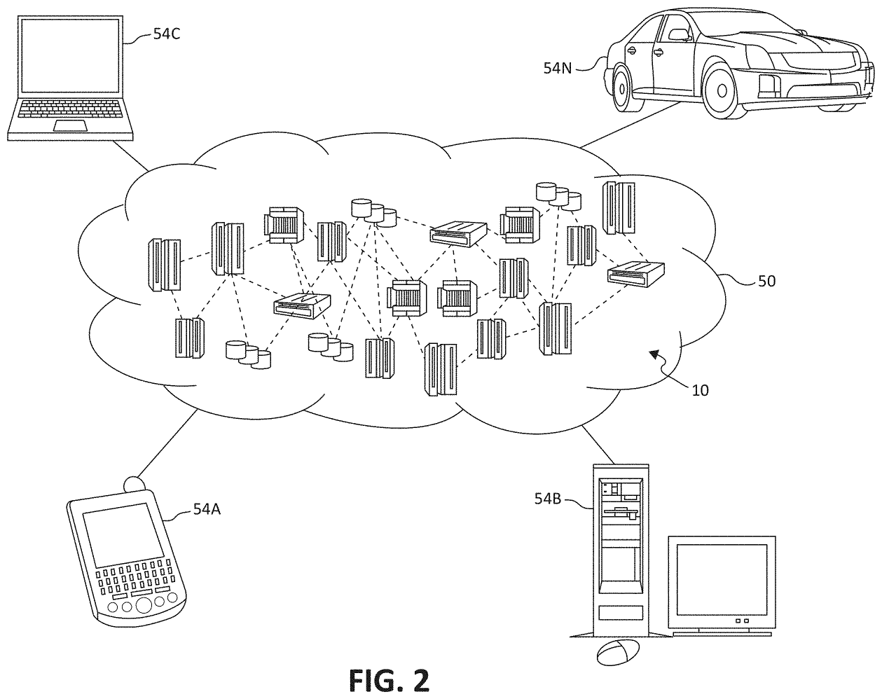

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

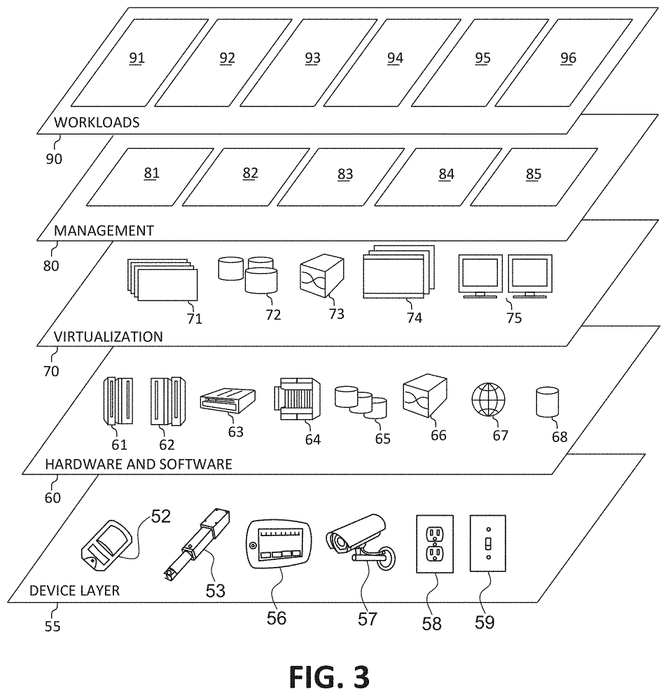

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing useful sets of top-K quality plans. In addition, workloads and functions 96 for providing useful sets of top-K quality plans may include such operations as data analysis, machine learning (e.g., artificial intelligence, natural language processing, etc.), user analysis, IoT sensor device detections, operation and/or analysis, as will be further described. One of ordinary skill in the art will appreciate that the workloads and functions 96 for providing useful sets of top-K quality plans may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the present invention provides for automating multidimensional elasticity providing top-K quality plans in a computing environment, again by a processor. A set of top-K quality plans using a quality bound for a planning problem, where K is a positive integer or assigned value. The planning problem may be reformulated in one or more subsequent iterations and forbidding one or more of the set of top-K quality plans. Identifying one or more of the set top-K quality plans having a quality less than the quality bound during the one or more subsequent iterations.

That is, the present invention may determine/compute a set of top quality plans via a planning operation. A planning problem (or multiple planning problems) may be formulated/received. A quality bound may be received. An optimal planner may be executed/run to obtain a set of plans. The planning problem may be reformulated so that exactly the identified plans and equivalent variants of those plans are forbidden in the following iterations. The planner may be executed/run until a plan of worse quality than the quality bound is found or there are no more plans exist. The quality bound may be specified explicitly in an absolute number. The quality bound may be specified relatively to the optimal solution quality q* (e.g., 120% of q* or q*+constant). The reformulation operation may be based on the planning problem obtained in the previous iteration and forbidding additional found plan and its equivalent plans. The reformulation may be based on the original planning problem and forbidding all plans found so far and their equivalent plans.

In one aspect, the present invention may iteratively generate plans and construct planning tasks with a reduced set of plans by forbidding exactly the plans having been identified up to a current point in time. The present invention may forbid not only a specific plan, but also all its possible reorderings. In order to achieve that, instead of forbidding plans as sequences of actions, the plans may be forbidden as multi-sets, which may require reformulation of a planning task that forbids all plans with the exact number of appearances for each action. The reformulation may forbid a single multi-set, and thus for a set of plans, the union of their multi-sets was forbidden in each consecutive iteration. In this way, possibly additional plans may be forbidden. At each iteration, the present invention may reformulate the original planning task to forbid all plans found so far. In this way, there is a need to maintain a mapping between the reformulated and original actions and keep the reformulated task size smaller.

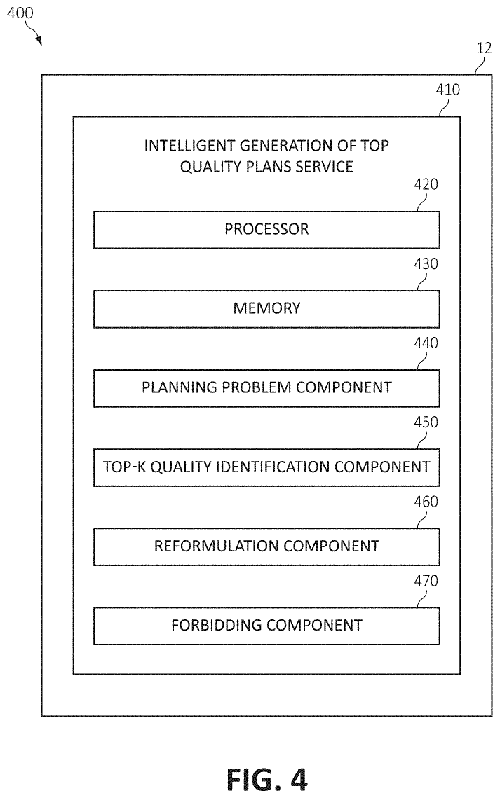

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. An intelligent generation of top quality plans service 410 (e.g., a planner) is shown, incorporating processing unit (“processor”) 420 to perform various computational, data processing and other functionality in accordance with various aspects of the present invention. The intelligent generation of top quality plans service 410 may be provided by the computer system/server 12 of FIG. 1. The processing unit 420 may be in communication with memory 430. The intelligent generation of top quality plans service 410 may include a planning problem component 440, a top-k quality plan identification component 450, a reformulation component 460, and a forbidding component 470.

As one of ordinary skill in the art will appreciate, the depiction of the various functional units in intelligent generation of top quality plans service 410 is for purposes of illustration, as the functional units may be located within the intelligent generation of top quality plans service 410 or elsewhere within and/or between distributed computing components.

In one embodiment, by way of example only, the planning problem component 440 may receive a planning problem and the quality bound for obtaining the set of top-K quality plans. The quality bound may be defined as an absolute number, and/or as a function of an optimal top quality plan.

The planning problem, in at least one embodiment, may include a finite set of facts, the initial state (a set of facts that are true initially), a finite set of action operators (with precondition and effects), and a goal condition. The planning problem may be described in, for example, a standard planning language called. (PDDL—Planning Domain Definition Language) or similar. For example, there are many problems that may be described in a planning problem. For example, travel planning may be described as a planning problem where the initial state is the set of facts true initially, for example, the agent's current location and the amount of money a user is willing to spend. The set of actions will include the different modes for transportation that will take the agent to various locations. The goal condition will be the agent's desired location. Other problems such as the logistic problem (the problem of transporting packages from an initial location to the goal location using various ways of transportation) can also be described in a planning problem. Received planning problem may hence come from different problems. In one embodiment, received planning problem may be a travel domain or the logistic domain. In further embodiment, received planning problem may be based on a hypothesis generation problem.

The top-K quality plan identification component 450 may identify, obtain, and/or represent a set of top-K quality plans using a quality bound for the planning problem.

The reformulation component 460 may reformulate the planning problem in one or more subsequent iterations and forbidding one or more of the set of top-K quality plans. In one aspect, the task reformulation may ignore orders between actions in a plan and thus also forbids all possible reorderings of a given plan, as well as all sub-plans.

The forbidding component 470 may forbid different ordering of action steps in the one or more of the set top-K quality plans while iteratively reformulating the planning problem until identifying one or more of the set top-K quality plans having a quality less than the quality bound. In an additional aspect, the forbidding component 470 may forbid both the one or more of the set top-K quality plans and one or more equivalent plans to the one or more of the set top-K quality plans in relation to the planning problem.

Thus, the top-K quality plan identification component 450 may identify at least one top quality plan from the set of top-K quality plans during a reformulation of the planning problem and the forbidding component 470 may forbid all remaining identified ones of the set of top-K quality plans and associated reordered equivalent quality plans of the set of top-K quality plans upon identifying the least one top quality plan.

In one aspect, for reformulation forbidding of a single plan, let [symbol] V, O, sₒ, s_{*} [symbol] be a planning task and π is a plan, where V is a finite set of finite-domain state variables, 0 is a finite set of actions, sₒ is an initial state, and s_{*} is the goals. A planning task may be defined (e.g., definition 1) as:

planning task Π_{π}⁻= [symbol] V′, O′, s′ₒ, s′_{*} [symbol] , (1),

and may be defined as

V′=V∪{v̅}∪{v̅₀|o∈π} (2),

where o is an action with v̅ being a binary variable, and

dom(v̅₀)={0, . . . , mₒ}, (3),

where dom(v) is a finite domain of variable v values and mₒ is the number of occurrences of o in π, and

O′={o^{e}|o∈Oπ}∪∪ᵢ₌₀^{m}^{ₒ}oᵢ^{f}|o∈π} (4),

where pre(o^{e})=pre(o),

eff(o^{e})=eff(o)∪{ [symbol] v̅, 0 [symbol] },

pre(oᵢ^{f})=pre(o){ [symbol] v̅₀, i [symbol] },

For 0≤i<mₒ, eff(oᵢ^{f})=eff(o)∪{ [symbol] v̅₀, i+1 [symbol] },

eff(oₘ_{ₒ}^{f})=eff(o)∪{ [symbol] v̅, 0 [symbol] }, and

cost′^{(o}^{^{e}}⁾=cost′(oᵢ^{f})=cost(o), 0≤i<mₒ,

s′ₒ[v]=sₒ[v] for all v∈V, s′ₒ[v̅]=1, and

s′ₒ[v̅₀]=0 for all o∈π, and

s′_{*}[v]=s_{*}[v]for all v∈V s.t.s_{*}[v] define, and s′_{*}[v̅]=0.

where pre(o) is a partial assignment called precondition and eff(o) is a partial assignment called effect and o has an associated natural number cost(o), called cost.

The semantics of the reformulation is as follows. The variable v̅ starts from the value 1 and switches to 0 when an action is applied that is not from plan π treated as a multi-set. Once a value 0 is reached indicating a deviation from plan π, it cannot be switched back to 1. The finite-domain variables v̅₀ may encode the number of applications of the action o. The actions o f i are copies of the action o in π, counting the number of applications of action o, as long as the number is not higher than the number of times it appears in π. Once the number of applications exceeds mₒ, the plan deviation is achieved by setting v̅ to 0.

In one aspect, in order to forbid multiple plans, a super-set of these plans may be forbidden by taking a super-set of the multi-sets representing the plans. In one aspect, when optimality is required, the present invention may present a reformulation that forbids exactly these plans and their sub-plans and the possible reorderings. The reformulation operation extends the above definition (e.g., definition 1), by introducing a binary variable for each plan, encoding whether the plan was deviated from.

In one aspect, for reformulation forbidding of multiple plan, let [symbol] V, O, sₒ, s_{*} [symbol] be a planning task, where P is a set of plans, and

Op={o|o∈π, π∈P} (5),

The planning task may be defined (e.g., definition 2) as:

planning task Π_{P}⁻= [symbol] V′, O′, s′ₒ, s′_{*} [symbol] , (6),

V′=V∪{v̅_{π}|π∈P}∪{v̅₀|o∈Op} (7),

where v̅_{π} being a binary variables, and

dom (v̅₀)={0, . . . , mₒ}, (8),

where dom(v) is a finite domain of variable v values and mₒ is

mₒ=max_{π∈P}{mₒ^{π}}, (9)

where mₒ^{π} is the number of occurrences of o in π, and

O′={o^{e}|o∈O\Op}∪{oᵢ^{f}|o∈Op0≤i<mₒ,} (10),

where pre(o^{e})=pre(o),

eff(o^{e})=eff(o)∪{ [symbol] v̅, 0 [symbol] },

pre(oᵢ^{f})=pre(o)={ [symbol] v̅₀, i [symbol] },

eff(o^{f})=eff(o)∪{ [symbol] v̅₀, i+1 [symbol] }∪{ [symbol] v̅_{π}, 0 [symbol] }i=mₒₚ^{π}}

for 0≤i<mₒ,

eff(oₘ_{ₒ}^{f})=eff(o)∪{ [symbol] v̅₉₀ , 0 [symbol] |π∈P}, and

cost′^{(o}^{^{e}}⁾=cost′(oᵢ^{f})=cost(o), 0≤i<mₒ,

s′ₒ[v]=sₒ[v] for all v∈V, s′ₒ[v̅]=1, for all π∈P, and

s′ₒ[v̅₀]=0 for all o∈π, and

s′_{*}[v]=s_{*}[v]for all v∈V s.t.s_{*}[v] define, and s′_{*}[v̅_{π}]=0 for all π∈P.

Thus, the operation/algorithm described herein exploits the reformulation in definition 2 to find a solution to the unordered top-quality planning problem. The operation/algorithm incrementally finds the set P of top quality plans. Starting with the empty set P=Ø and assuming planning task Πₚ⁻=Π, the intelligent generation of top quality plans service 410 may be executed iteratively to find an optimal plan π to the planning task Π−P. Once a plan is found/identified, the plan may be added to the set of found plans P. Then, the new reformulation Π−P is constructed from Π for a next iteration. The algorithm stops when a plan π is generated such that cost(π)>q. It should be noted that the algorithm results in a set P of sequential plans, with no two plans being reorderings of each other. At each iteration, after the plan π was found, structural symmetries may be used to generate from π additional plans that are symmetric to plan π, and add these that are not reorderings of plan π to the set P. Finally, since the first step results in an optimal plan, the quality can be defined relatively to the cost of the optimal plan rather than an absolute number.

It should be noted that, by way of example only, one or more components of the intelligent generation of top quality plans service 410 such as, for example, the planning problem component 440 may determine one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

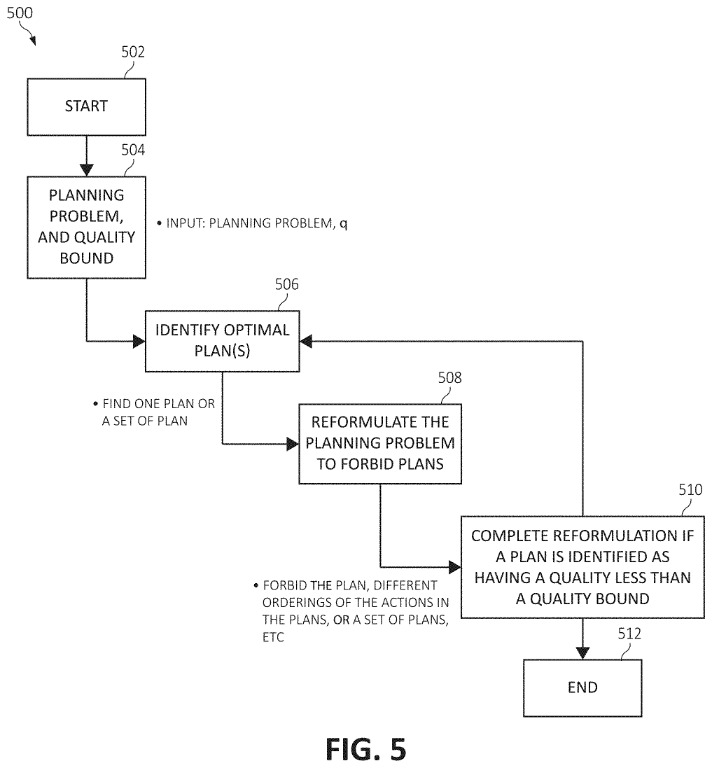

Turning now to FIG. 5, a block diagram of exemplary functionality 500 relating to providing top-K quality plans is depicted, for use in the overall context of intelligent generation of useful top-K quality plans according to various aspects of the present invention. In one aspect, one or more of the components, modules, services, applications, and/or functions described in FIGS. 1-4 may be used in FIG. 5.

As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for image enhancement in accordance with the present invention. Many of the functional blocks 500 may execute as background processes on various components, either in distributed computing components, or on the user device, or elsewhere.

Starting with block 502, data may be input such as, for example, a planning problem with a quality bound (“q”) and the planning problem and quality bound may be received, as in block in 504. One or more top-k quality plans (e.g., optimal plans) may be identified (in relation to the planning problem and the quality bound), as in block 506. The planning problem may be reformulated to forbid each of the top-k quality plans (heretofore identified), as in block 508. In block 510, the reformulation of the planning problem is completed if one or more of the set top-K quality plans has a quality less than the quality bound (e.g., a plan identified having a quality worse than the quality bound (“q”) is identified). If one or more of the set top-K quality plans does not have a quality less than the quality bound, the operation may return back to block 506 to identify one or more additional/new top-k quality plan. The operations/functionality of blocks 500 may also end, as in block 512.

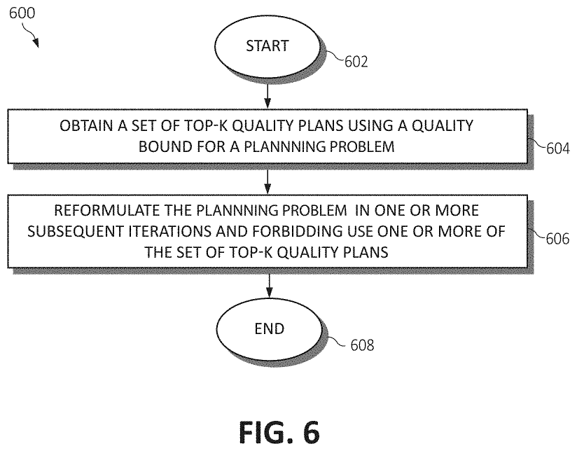

Turning now to FIG. 6, a method 600 for providing useful sets of top-K quality plans in a computing environment is depicted, in which various aspects of the illustrated embodiments may be implemented. The functionality 600 may be implemented as a method executed as instructions on a machine, where the instructions are included on at least one computer readable medium or on a non-transitory machine-readable storage medium. The functionality 600 may start in block 602.

A set of top-K quality plans using a quality bound for a planning problem, as in block 604. The planning problem may be reformulated in one or more subsequent iterations and forbidding one or more of the set of top-K quality plans, as in block 606. The

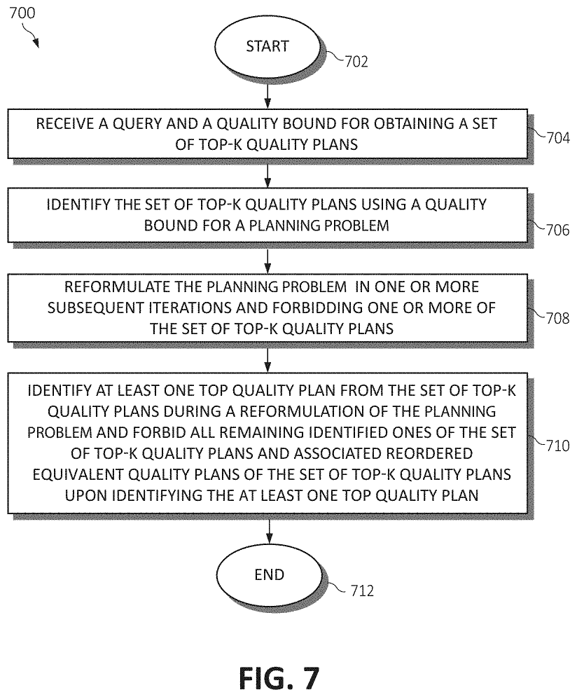

Turning now to FIG. 7, an additional method 700 for providing useful sets of top-K quality plans in a computing environment is depicted, in which various aspects of the illustrated embodiments may be implemented. The functionality 700 may be implemented as a method executed as instructions on a machine, where the instructions are included on at least one computer readable medium or on a non-transitory machine-readable storage medium. The functionality 700 may start in block 702.

A planning problem and a quality bound may be received for obtaining the set of top-K quality plans, as in block 704. A set of top-K quality plans may be identified using the quality bound for the planning problem, as in block 706. The planning problem may be reformulated in one or more subsequent iterations and one or more of the set of top-K quality plans may be forbidden, as in block 708. At least one top quality plan may be identified from the set of top-K quality plans during a reformulation of the planning problem and all remaining identified ones of the set of top-K quality plans and associated reordered equivalent quality plans of the set of top-K quality plans may be forbidden upon identifying the at least one top quality plan, as in block 710. The functionality 700 may end at block 710.

In one aspect, in conjunction with and/or as part of at least one block of FIGS. 6-7, the operations of methods 600 and/or 700 may include each of the following. The operations of methods 600 and/or 700 may define the quality bound as an absolute number, and/or define the quality bound as function of an optimal top quality plan.

The methods 600 and/or 700 may forbid different ordering of action steps in the one or more of the set top-K quality plans while iteratively reformulating the planning problem until identifying one or more of the set top-K quality plans having a quality less than the quality bound, and/or forbid both the one or more of the set top-K quality plans and one or more equivalent plans to the one or more of the set top-K quality plans in relation to the planning problem.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for providing top-K quality plans in a computing environment, comprising:
obtaining a set of top-K quality plans using a quality bound for a planning problem; and
reformulating the planning problem in one or more subsequent iterations and forbidding use of one or more of the set of top-K quality plans.

2. The method of claim 1, further including receiving the planning problem and the quality bound for obtaining the set of top-K quality plans.

3. The method of claim 1, further including defining the quality bound as an absolute number.

4. The method of claim 1, further including defining the quality bound as function of a optimal top quality plan.

5. The method of claim 1, further including forbidding different ordering of action steps in the one or more of the set top-K quality plans while iteratively reformulating the planning problem until identifying one or more of the set top-K quality plans having a quality less than the quality bound.

6. The method of claim 1, further including forbidding both the one or more of the set top-K quality plans and one or more equivalent plans to the one or more of the set top-K quality plans in relation to the planning problem.

7. The method of claim 1, further including:
identifying at least one top quality plan from the set of top-K quality plans during a reformulation of the planning problem; and
forbidding all remaining identified ones of the set of top-K quality plans and associated reordered equivalent quality plans of the set of top-K quality plans upon identifying the at least one top quality plan.

8. A system for providing top-K quality plans in a computing environment, comprising:
one or more computers with executable instructions that when executed cause the system to:
obtain a set of top-K quality plans using a quality bound for a planning problem; and
reformulate the planning problem in one or more subsequent iterations and forbidding use of one or more of the set of top-K quality plans.

9. The system of claim 8, wherein the executable instructions further receive the planning problem and the quality bound for obtaining the set of top-K quality plans.

10. The system of claim 8, wherein the executable instructions further define the quality bound as an absolute number.

11. The system of claim 8, wherein the executable instructions further define the quality bound as function of a optimal top quality plan.

12. The system of claim 8, wherein the executable instructions further forbid different ordering of action steps in the one or more of the set top-K quality plans while iteratively reformulating the planning problem until identifying one or more of the set top-K quality plans having a quality less than the quality bound.

13. The system of claim 8, wherein the executable instructions further forbid both the one or more of the set top-K quality plans and one or more equivalent plans to the one or more of the set top-K quality plans in relation to the planning problem.

14. The system of claim 8, wherein the executable instructions further:
identify at least one top quality plan from the set of top-K quality plans during a reformulation of the planning problem; and
forbid all remaining identified ones of the set of top-K quality plans and associated reordered equivalent quality plans of the set of top-K quality plans upon identifying the at least one top quality plan.

15. A computer program product for providing top-K quality plans by a processor, the computer program product comprising a non-transitory computer-readable storage medium having computer-readable program code portions stored therein, the computer-readable program code portions comprising:
an executable portion that obtains a set of top-K quality plans using a quality bound for a planning problem; and
an executable portion that reformulates the planning problem in one or more subsequent iterations and forbidding use of one or more of the set of top-K quality plans.

16. The computer program product of claim 15, further including an executable portion that receives the planning problem and the quality bound for obtaining the set of top-K quality plans.

17. The computer program product of claim 15, further including an executable portion that:
defines the quality bound as an absolute number; or
defines the quality bound as function of a optimal top quality plan.

18. The computer program product of claim 15, further including an executable portion that forbids different ordering of action steps in the one or more of the set top-K quality plans while iteratively reformulating the planning problem until identifying one or more of the set top-K quality plans having a quality less than the quality bound.

19. The computer program product of claim 15, further including an executable portion that forbids both the one or more of the set top-K quality plans and one or more equivalent plans to the one or more of the set top-K quality plans in relation to the planning problem.

20. The computer program product of claim 15, further including an executable portion that:
identifies at least one top quality plan from the set of top-K quality plans during a reformulation of the planning problem; and
forbids all remaining identified ones of the set of top-K quality plans and associated reordered equivalent quality plans of the set of top-K quality plans upon identifying the at least one top quality plan.
